(19) United States
(12) Patent Application Publication
(10) Pub. No.: US 2008/0079665 A1
(43) Pub. Date: Apr. 3, 2008

(54) DRIVE METHOD FOR PLASMA DISPLAY PANEL AND DISPLAY DEVICE

(75) Inventors: SHIH-FANG WONG, Tu-Cheng (TW); JIANG-FENG SHAN, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/778,661

(22) Filed: Jul. 17, 2007

(30) Foreign Application Priority Data
Sep. 29, 2006 (CN) 200610062896.1

(51) Int. Cl. G11B 15/04

(52) U.S. Cl. 345/60

(57) ABSTRACT

A plasma display device includes a plasma display panel, a signal processor, a scan electrode driver, a sustain electrode driver, and an address electrode driver. The plasma display panel includes address electrodes, scan electrodes, and sustain electrodes. The signal processor is used for generating scan drive signals, sustain drive signals and address drive signals in operation. The operation includes an address period, a sustain period, and a set-up period. The address electrode driver may apply an excitation signal to the address electrodes during the sustain period. A drive method for the plasma display device is also disclosed.

### BACKGROUND OF THE INVENTION

1. Field of the Invention

The present invention generally relates to display devices, and more particularly to a plasma display panel and drive method of the same.

2. Description of Related Art

Plasma display panels (PDPs) have become more and more common. In the PDPs, a gas is ionized to emit ultraviolet light. The ultraviolet light is guided to excite fluorescent materials, thus the fluorescent materials emit visible light and illuminate a plurality of pixels on a panel. The pixels collectively form a displayed image.

Referring to FIG. 6, an exploded view of a PDP is illustrated. The PDP includes a rear glass substrate 10, a front glass substrate 20 parallel with the rear glass substrate 10. A dielectric layer 12 and a protection layer 14 are deposited between and parallel to the rear glass substrate 10 and the front glass substrate 20. A scan electrode 16 and a sustain electrode 18 are sandwiched between the rear glass substrate 10 and the dielectric layer 12. A plurality of address electrodes 22 are set on the front glass substrate 20, the address electrodes 22 are set perpendicular to the scan electrode 16 and the sustain electrode 18.

An insulation layer 24 is sandwiched between the rear glass substrate 10 and the front glass substrate 20. A plurality of barriers 26 are disposed on the insulation layer 24 facing the dielectric layer 12 and the protection layer 14. The barriers 26 are also strips, and set along a direction parallel with that of the address electrodes 22. Fluorescent materials 28 are smeared on the barriers 26.

A discharge space 30 is defined between the barriers 26 and the scan electrode 16, and also between the barriers 26 and the sustain electrode 18. The barriers 26 and the scan electrode 16, the sustain electrode 18 respectively divides the discharge space 30 into many discharge cells 32. The discharge cells 32 are filled with the gas that may be a mixture of neon and xenon.

However, because the discharge space 30 in the PDP is rather small, the energy efficiency of the PDP may be very low, commonly 1.4%. Further, the energy conversion efficiency of the fluorescent materials is about 20%. Furthermore, the PDP of such kind has a relatively low brightness. If sufficient brightness is needed, a lot of energy is needed, thus the power consumption of the PDP would become very high, and a large amount of heat is generated. This will cause problems to a heat sink, making the PDP an uneconomical display device.

Therefore, a need exists in the industry for a plasma display panel with high efficiency.

### SUMMARY OF THE INVENTION

A plasma display device includes a plasma display panel, a signal processor, a scan electrode driver, a sustain electrode driver, and an address electrode driver. The plasma display panel is used for displaying images. The plasma display panel includes address electrodes, scan electrodes, and sustain electrodes. The signal processor is used for receiving image signals, and generating scan drive signals, sustain drive signals and address drive signals in operation. The operation includes an address period during which the plasma display panel may be lighted, a sustain period during which the lighting of the plasma display panel is sustained, and a set-up period during which the plasma display panel is set up. The scan electrode driver is used for applying scan pulses to the scan electrodes according to the scan drive signals. The sustain electrode driver is used for applying sustain pulses to the sustain electrodes according to the sustain drive signals. The address electrode driver is used for applying address pulses to the address electrodes according to the address drive signals. The address electrode driver may apply an excitation signal to the address electrodes during the sustain period.

A drive method for a plasma display panel including scan electrodes, sustain electrodes, and address electrodes, wherein the drive method includes following steps of: receiving image signals; generating scan drive signals, sustain drive signals, and address drive signals during an address period for lighting the plasma display panel, a sustain period for sustaining the lighting of the plasma display panel, and a set-up period for setting up the plasma display panel; applying scan pulses to the scan electrodes according to the scan drive signals; applying sustain pulses to the sustain electrodes according to the sustain drive signals; applying address pulses to the address electrodes according to the address drive signals; and applying an excitation signal to the address electrodes during the sustain period.

Other systems, methods, features, and advantages of the present plasma display device and drive method thereof will be or become apparent to one with skill in the art upon examination of the following drawings and detailed description. It is intended that all such additional systems, methods, features, and advantages be included within this description, be within the scope of the present system and method, and be protected by the accompanying claims.

### BRIEF DESCRIPTION OF THE DRAWINGS

Many aspects of the present plasma display device and drive method thereof can be better understood with reference to the following drawings. The components in the drawings are not necessarily to scale, emphasis instead being placed upon clearly illustrating the principles of the inventive system and method. Moreover, in the drawings, like reference numerals designate corresponding parts throughout the several views.

FIG. 1 is a schematic view of a plasma display device in accordance with an exemplary embodiment;

FIG. 2 is a cross-sectional view of a discharge cell according to an exemplary embodiment;

FIG. 3 is a time diagram of a drive method for the plasma display panel in accordance with an exemplary embodiment;

FIG. 4 is a time diagram of an experimental operation of a PDP in accordance with an exemplary embodiment;

FIG. 5 shows a result of the experimental operation; and

FIG. 6 is an exploded view of a typical plasma display panel.

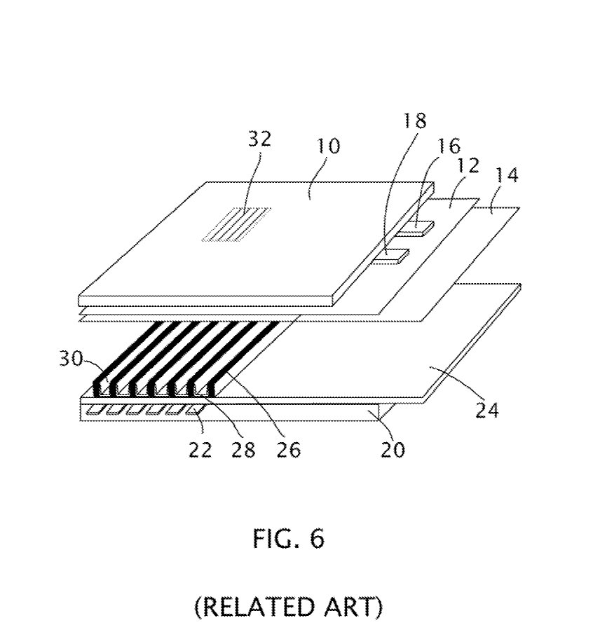

### DETAILED DESCRIPTION OF THE INVENTION

Reference will now be made to the drawings to describe a preferred embodiment of the inventive plasma display panel and drive method for the plasma display panel.

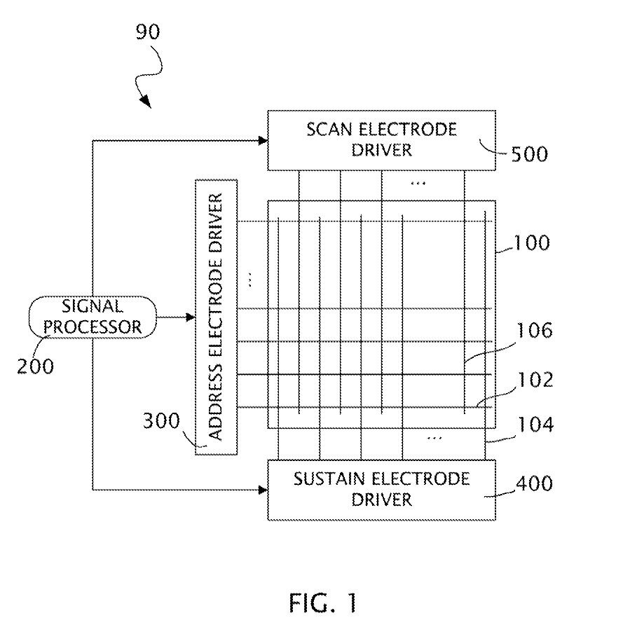

Referring to FIG. 1, a schematic view of a plasma display device in accordance with an exemplary embodiment is illustrated. The plasma display device (PDD) 90 includes a plasma display panel (PDP) 100, a signal processor 200, an address electrode driver 300, a sustain electrode driver 400, and a scan electrode driver 500.

The PDP 100 includes a front glass substrate and a rear glass substrate (not shown). A gas is filled between the two substrates. A discharge space is defined between the two substrates. Rows of address electrodes 102, columns of sustain electrodes 104 and scan electrodes 106 are arranged in the discharge space. The sustain electrodes 104 and the scan electrodes 106 are disposed in the discharge space in an alternating manner. The address electrodes 102 are disposed perpendicular to the sustain electrodes 104 and the scan electrodes 106. The discharge space is thus divided into many discharge cells bounded by the address electrodes 102, the sustain electrodes 104, and the scan electrodes 106.

The signal processor 200 is used for receiving image signals, and generating address drive signals, sustain drive signals, and scan drive signals to respectively control the address electrodes 102, the sustain electrodes 104, and the scan electrodes 106 while the PDD is in use. The PDP 100 is operated in three periods, i.e. an address period, a sustain period, and a set-up period.

During the address period, the signal processor 200 outputs the address drive signal to the address electrode driver 300. After receiving the address drive signal, the address electrode driver 300 sends out an address signal to the address electrodes 102. The address signal includes a series of positive address pulses. The signal processor 200 also outputs the scan drive signal to the scan electrode driver 500, and the scan electrode driver 500 accordingly sends out negative scan pulses to assign corresponding scan electrodes 106. The gas filled in discharge cells that are bounded by the address electrodes 102 and the assigned scan electrodes 106 is discharged. This causes the gas to be ionized, and divided into ions and electrons accordingly. The ions rush towards the scan electrodes 106, and the electrons rush towards the address electrodes 102. At an end of the address period, a wall voltage is formed between the assigned scan electrodes 106 and the address electrodes 102, with the scan electrodes 106 being an anode.

During the sustain period, the signal processor 200 simultaneously outputs the sustain drive signal and the scan drive signal to the sustain electrode driver 400 and the scan electrode driver 500 respectively. The sustain electrode driver 400 then send first sustain pulses to the sustain electrodes 104, and the scan electrode driver 500 send second sustain pulses to the scan electrodes 106, respectively. The first and second sustain pulses are applied alternatively, this is for performing maintenance of the lighting of the PDP 100.

During the set-up period, the sustain electrode driver 400 sends a first set-up signal to the scan electrode 106, and the scan electrode driver 500 sends a second set-up signals to the sustain electrode 104. The first and second set-up signals are in a trapeziform form. The ions and the electrons move towards each other to counteract remained charges, thus initializing the discharge cells.

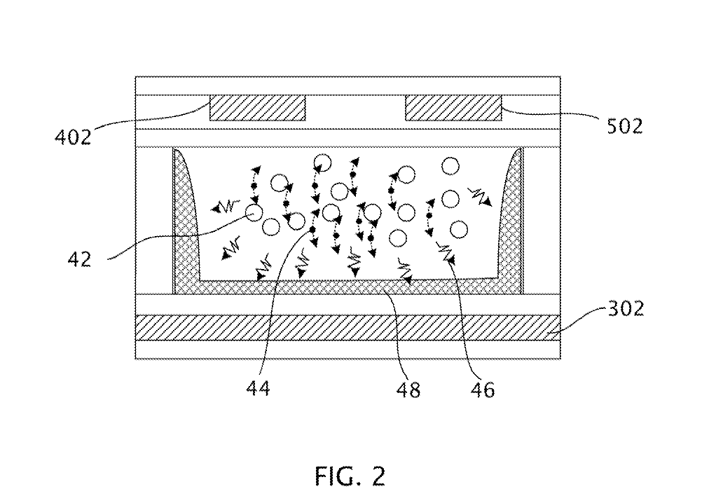

Referring to FIG. 2, a cross-sectional view of one discharge cell according to an exemplary embodiment is illustrated. A principle of the lighting of the PDP 100 can be explained with reference to the FIG. 2 as well. When the gas in the discharge cells is ionized, the gas is divided into ions 42 and electrons 44. During the sustain period, sustain pulses are alternatively sent to the sustain electrodes 402 and the scan electrodes 502, thus the ions 42 and the electrons 44 rush towards each other. When the ions 42 and the electrons 44 collide with each other, ultraviolet light 46 is emitted. The ultraviolet light 46 are projected to the fluorescent materials 48 and excite the fluorescent materials 48 to emit visible light. The brightness of the PDP mainly depends on the intensity of the ultraviolet light 46. It can be seen from the above description that the intensity of the ultraviolet light 46 depends on a collision frequency between the ions 42 and the electrons 44. Many methods have been used to increase the collision frequency between the ions 42 and the electrons 44. Such methods include: increasing a density of the gas, or adjusting a frequency of the sustain pulses. However, when using these methods, the pulses with high levels are required.

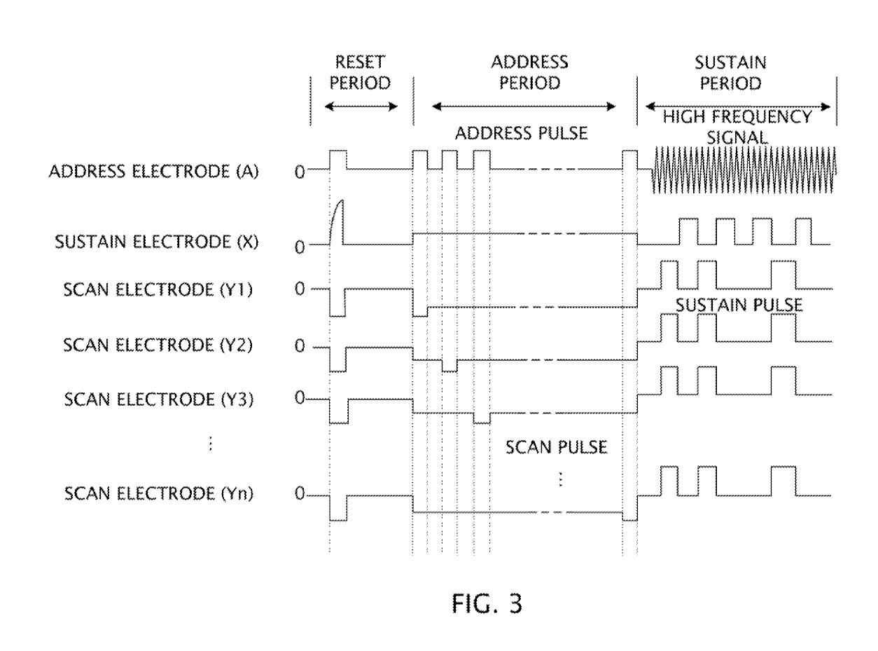

Referring to FIG. 3, a time diagram of a drive method for the PDP in accordance with an exemplary embodiment is illustrated. During the sustain period, the address electrode driver sends out an excitation signal to the address electrodes 302 according to the address drive signal received from the signal processor (not shown). Preferably, the frequency is between 500 KHz and 5 MHz, but a higher frequency may also be used. In the below description, as an example, an excitation signal in a sinusoidal form with a frequency of 1 MHz is applied to the address electrodes 302 during the sustain period. During the sustain period, the first sustain pulses and the second sustain pulses are respectively applied to the sustain electrodes 402 and the scan electrodes 502. The first and second sustain pulses are applied in an alternating manner.

A relationship between the frequency of the excitation signal and the collision frequency between the ions 42 and the electrons 44 will be discussed hereinafter. As the excitation signal is sent to the address electrodes 302, an electric field is formed in the discharge cell. The force exerted on a charge (ions 42 and electrons 44) in an electromagnetic field is given by the “Lorentz Force”. According to the Equation given by F·t=m·v, a velocity change v of the ions 42 and the electrons 44 mainly depends on a time t that the Lorentz Force (F) are applied and a mass m of the ions 42 and the electrons 44. In the equation, “F·t” is called an “impulse”, and “m·v” is called “momentum”. Since the mass of the ions 42 are much larger than that of the electrons 44, the velocity change of the ions 42 are much smaller than that of the electrons 44. As the frequency of the excitation signal applied to the address electrodes 302 becomes higher, the time t becomes shorter, and the velocity change v of the ions 42 becomes smaller. When the frequency of the excitation signal is too high to cause the ions 42 to accelerate, the ions 42 would not move. When the frequency of the excitation signal is 13 MHz, the ions 42 would not be affected by the excitation signal applied to the address electrode 302. The mass m of the electrons 44 are small enough that the electrons 44 can always be affected by the excitation signals as the frequency grows higher and higher. As the excitation signal is sinusoidal, the electric field oscillates to force the electrons 44 to move back and forth, thus the collision frequency between the electrons 44 and the ions 42 increases greatly. The intensity of the ultraviolet light 46 increases as the electrons 44 hit more ions 42, and the brightness of the PDP is increased.

An experiment is carried out for testing a performance of the PDP when a excitation signal is applied to the address electrode. The gas filled between the front glass substrate and the rear substrate of the PDP is a mixture of neon and xenon, and has an air pressure of 500 Torr. The PDP also has a dielectric layer with a thickness of 30 microns, and a protection layer with a thickness of 700 to 900 nano-meters. Each pixel of the PDP is a square with a length and width of 1.08 millimeters, and each discharge cell relative to the pixel is divided by a plurality of strip shaped barriers with a height of 100 microns.

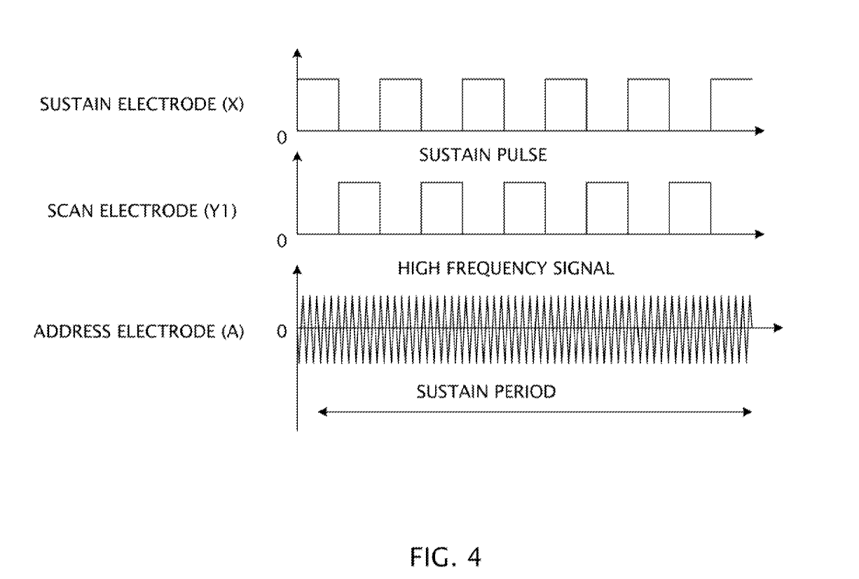

Referring to FIG. 4, a time diagram illustrating an experimental operation of a PDP in accordance with an exemplary embodiment. For simplicity, only the sustain pulses and the excitation signal in the sustain period are applied to the PDP, thus, because there is no address signal or set-up signal, the PDP tends to display a totally white image. As shown in FIG. 4, during the sustain period, first and second sustain pulses with a frequency of 50 KHz are respectively applied to the sustain electrodes 402 and the scan electrodes 502, an excitation signal with a frequency up to 1 MHz or even higher is applied to the address electrodes 302.

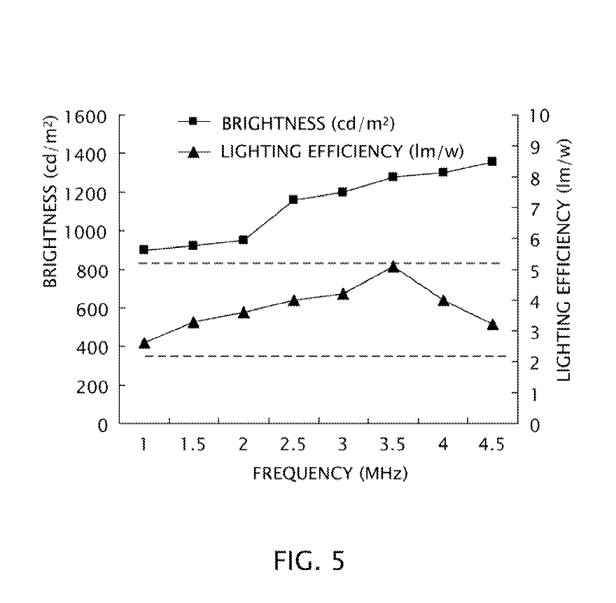

The experimental result is illustrated in FIG. 5. The brightness of the PDP increases as the frequency of the excitation signal to the address electrodes increases. However, the lighting efficiency of the PDP decreases as the frequency of the excitation signal applied to the address electrodes increases over 3.5 MHz. Thus, the optimal frequency for the excitation signal is between 1 MHz to 4.5 MHz, with 3.5 MHz resulting in a best lighting efficiency.

The drive method for the plasma display device and the PDP increases the lighting efficiency of the PDP by applying a excitation signal to the address electrodes instead of increasing the size of the PDP or increasing the air pressure of the gas, the physical structure of the plasma display device or the PD, such as the gas and the fluorescent materials, do not have to be changed.

What is claimed is:

1. A plasma display device comprising:
a plasma display panel for displaying images, the plasma display panel comprising address electrodes, scan electrodes, and sustain electrodes;
a signal processor for receiving image signals, and generating scan drive signals, sustain drive signals and address drive signals in operation, the operation comprising an address period during which the plasma display panel may be lighted, a sustain period during which the lighting of the plasma display panel is sustained, and a set-up period during which the plasma display panel is set up;
a scan electrode driver for applying scan pulses to the scan electrodes according to the scan drive signals;
a sustain electrode driver for applying sustain pulses to the sustain electrodes according to the sustain drive signals; and
an address electrode driver for applying address pulses to the address electrodes according to the address drive signals, wherein the address electrode driver may apply an excitation signal to the address electrodes during the sustain period.

2. The plasma display device as claimed in claim 1, wherein a frequency of the excitation signal is at least 1 MHz.

3. The plasma display device as claimed in claim 1, wherein the excitation signal is sinusoidal.

4. The plasma display device as claimed in claim 1, wherein a frequency of the excitation signal is between 1 MHz and 4.5 MHz.

5. The plasma display device as claimed in claim 1, wherein a frequency of the excitation signal is 3.5 MHz.

6. The plasma display device as claimed in claim 1, wherein the plasma display panel further comprises a front glass substrate and a rear glass substrate that define a discharge space therebetween.

7. The plasma display device as claimed in claim 6, wherein the discharge space is filled by a gas.

8. The plasma display device as claimed in claim 6, wherein the address electrodes, the scan electrodes, and the sustain electrodes are secured in the discharge space.

9. The plasma display device as claimed in claim 8, wherein the address electrodes, the scan electrodes, and the sustain electrodes divide the discharge space into many discharge cells.

10. A drive method for a plasma display panel including scan electrodes, sustain electrodes, and address electrodes, wherein the drive method comprising following steps of:
receiving image signals;
generating scan drive signals, sustain drive signals, and address drive signals during an address period for lighting the plasma display panel, a sustain period for sustaining the lighting of the plasma display panel, and a set-up period for setting up the plasma display panel;
applying scan pulses to the scan electrodes according to the scan drive signals;
applying sustain pulses to the sustain electrodes according to the sustain drive signals;
applying address pulses to the address electrodes according to the address drive signals; and
applying an excitation signal to the address electrodes during the sustain period.

11. The drive method as claimed in claim 10, wherein a frequency of the excitation signal is at least 1 MHz.

12. The drive method as claimed in claim 10, wherein the excitation signal is sinusoidal.

13. The drive method as claimed in claim 10, wherein a frequency of the excitation signal is between 1 MHz and 4.5 MHz.

14. The drive method as claimed in claim 10, wherein a frequency of the excitation signal is 3.5 MHz.
